(19) United States
(12) Patent Application Publication
(10) Pub. No.: US 2008/0027696 A1
(43) Pub. Date: Jan. 31, 2008

(54) DISPLAY OF INFORMATION REGARDING THE THERAPEUTIC OR DIAGNOSTIC EFFECTS

(76) Inventors: Christoph Pedain, Munchen (DE); Maria Inmaculada Rodriguez-Ponce, Munchen (DE)

Correspondence Address: DON W. BULSON (BrainLAB), RENNER, OTTO, BOISSELLE & SKLAR, LLP, 1621 EUCLID AVENUE - 19TH FLOOR, CLEVELAND, OH, 44115, US

(21) Appl. No.: 11/828,552

(22) Filed: Jul. 26, 2007

Related U.S. Application Data
(60) Provisional application No. 60/821,305, filed on Aug. 3, 2006.

(30) Foreign Application Priority Data
Jul. 27, 2006 (EP) 06015667

(51) Int. Cl. G06G 7/60

(52) U.S. Cl. 703/11

(57) ABSTRACT

A method for simulating a distribution of at least one agent in a subject includes using the combination of subject-specific information, information concerning the administration of the at least one agent, and agent specific information to calculate an effect of the at least one agent in the subject, wherein the effect includes the alteration of the metabolism.

### RELATED APPLICATION DATA

This application claims priority of U.S. Provisional Application No. 60/821,305 filed on Aug. 3, 2006, which is incorporated herein by reference in its entirety.

### FIELD OF THE INVENTION

The present invention relates to the display of information regarding therapeutic or diagnostic effects. More specifically, the present invention relates to a method and device for improving the simulation and display of the spatial distribution of a therapeutic and/or diagnostic agent in biological tissue, preferably in combination with information regarding the efficiency or effect of the agent on the targeted tissue.

### BACKGROUND OF THE INVENTION

U.S. Pat. No. 5,995,864 discloses a system for displaying a model of isodoses used in boron neutron capture therapy (BNCT). This enables a graphic display of an image of a desired anatomical feature of a patient with isodose contours superimposed thereon to reflect radiotherapy treatment.

### SUMMARY OF THE INVENTION

The distribution of at least an agent in tissue is simulated or calculated, wherein patient or subject-specific information is used together with agent specific information to carry out the simulation and/or calculation. From the combination of the patient/subject specific information and the agent specific information, regions within the patient/subject where the agent, which is administered to the patient/subject (e.g., infused or injected into the patient/subject) has an effect in or on the patient/subject, e.g., an effect in specific tissue, can be calculated. Additionally, information regarding the administration can be used to calculate the effect, rate or degree of the effect. The patient/subject-specific information can be information regarding physiology, anatomy, vascular permeability, hydraulic conductivity, diffusivity and/or any other information that can be used to describe the structure or properties of the structure of the subject or patient. The agent specific information, for example, can be any information that describes the effect or behavior of an agent, such as a therapeutic and/or diagnostic substance and/or a carrier substance thereof, which could be information regarding the metabolization, loss, influx and/or efflux of the agent or substance. Using the patient specific information together with the agent specific information, it can be calculated which effect or effects this agent or substance has in the patient when it is known where and how this agent is brought into the patient. The effect of the substance on the patient or tissue can include binding, necrosis, swelling, uptake, metabolic alterations, genetic alterations, physical alterations, chemical alterations, electrical alterations, morphologic alterations, mutations, physiological alterations or any kind of change of the internal structure of the patient or effects on the tissue of the patient.

Thus, the method can be based on patient-specific information together with information about the properties of the administered agent, such as metabolic tissue-dependent properties, molecule degradation and/or other transport properties. Further, the method can take into account physiological tissue properties, like vascular permeability, hydraulic conductivity, pore fraction and diffusivity.

The method provided herein enables the user to obtain a prediction of the potential success of the treatment in terms not only of the area covered, but also in terms of the local therapeutic and/or diagnostic effects. In one embodiment, the degree or distribution of the effect(s) can be obtained.

Thus, the distribution of the administered agent can be simulated and can be displayed with regard to the physiological impact on the covered tissue. The method considers not only the covered target area, but also the therapeutic and/or diagnostic capabilities of the agent on this area, which also effects the efficacy of the treatment.

Therefore, using the inventive method, the dose for achieving a desired effect on a targeted area can be calculated to obtain the desired degree of the therapeutic effect. This is advantageous, as for some therapeutic agents the incorrect dose can lead to no effect or even undesired effects (e.g., toxic effects).

Since it is possible to also take the patient dependency into account, in addition to the agent dependency, the therapeutic efficiency can be simulated and predicted. Further, it can be determined how and why some specific agent or drug is effective for some patient groups and inefficient or ineffective for others.

A simulation can be performed and, using the results of the simulation, it can be determined whether or not a specific drug or agent is efficient when used or administered in combination with another drug or agent. Using the method for simulating the distribution of an agent in tissue for two or more administered agents or drugs, it can be determined whether there is any interaction between the respective administered agents or substances. This interaction may be a direct interaction or in interaction with the patient/subject (e.g., metabolization), and whether or not the combined administration of these substances effects the efficiency of each single administered agent.

If a diagnostic agent is administered (e.g., chelates of Gadolinium, which has a well-known diagnostic effect for the recognition of a brain tumor), all doses of the diagnostic agent may not be useful for identifying the tumor. Using the method provided herein, the information regarding the desired diagnostic effect can be used to calculate by way of simulation the dose and manner by which the agent is administered. This can be made available for a specific patient prior to the treatment procedure starts or to track therapeutic effects during a treatment.

Preferably, the therapeutical and or diagnostic agents are administered by convection-enhanced delivery methods, which are also referred to as high-flow microinfusion, or by diffusional delivery methods, which are also referred to as low-flow microinfusion. The therapeutic or diagnostic substance or portions thereof can thus be applied locally using a pressure-driven infusion delivery or a diffusion mediated delivery. It is further possible to orally administer a substance or an agent or in general to apply an agent systemically using the bloodstream and/or other body fluids of a patient/subject as the transport mechanism to the volume of interest.

Furthermore, the inventive method for simulating the distribution can be applied on the respective delivery methods to examine the effect of the administered substance on the respective transport mechanism, such as an intravenous administration. It is also possible to perform a topical administration so that the parts of a body or patient involved in the topical delivery are considered as the volume of interest for simulating the distribution of the agent.

Preferably the choice of the substance property to be displayed depends on the expected effect or response on the tissue. This effect may be determined by a single property or by a combination of different properties. A pre-determined effect, for example, can be a metabolic change of the tissue or tumor growth changes. Therefore, the property of the substance to be displayed could be for those cases metabolic/reaction activity or local substance concentration, respectively.

The method can focus on the therapeutic and/or diagnostic effects triggered by the activation or alteration of a body, body structure or tissue by the effect of the administered agent or substance.

Also provided is a computer program which, when loaded or running on a computer, performs the method as described herein, and to a program storage medium or computer program product comprising such a computer program.

An apparatus for implementing the method described herein comprises a computer, a display unit coupled to the computer and a computer program as mentioned above, which uses the patient-specific information, information about the administration of and information specific to a therapeutic and/or diagnostic substance and combines these pieces of information to calculate and simulate the distribution of the substance or agent in the patient or in a specific subject or tissue to generate an image which can be output on the display to display regions in which the therapeutic and/or diagnostic substance has an assumed effect on a volume of interest within the subject or patient. The computer or processor can be programmed to process information supplied by the planner to develop a graphical representation of the volume of interest or anatomical feature undergoing treatment, to develop a visual representation of the propagation of the agent (contour lines).

Additionally, signals can be processed to generate a visual display of the targeted tissue. Efficiency contour lines representative of the degree of the effect can be superimposed over the volume of interest or anatomical feature displayed so as to indicate the effect of the administered substance on the patient.

The method and apparatus provide a convenient way for a planner to examine which effect an administered substance on a targeted tissue has accounting for tissue-specific biological factors and concentration.

### BRIEF DESCRIPTION OF THE DRAWINGS

The forgoing and other features of the invention are hereinafter discussed with reference to the drawing.

FIG. 1 is a flow chart of an exemplary method of simulating the effect of an administered substance in accordance with the invention.

FIG. 2 is a flow chart of another exemplary method of simulating the effect of an administered substance in accordance with the invention.

FIG. 3 is a block diagram of an exemplary apparatus for implementing the method in accordance with the invention, including a graphical display, a general purpose computer, a keyboard and a database for entering data.

### DETAILED DESCRIPTION

A method for displaying the regions in which an administered substance has an assumed effect includes using the combination of patient-specific and agent-specific information to calculate and then display the distribution of the effect. The display may be in the form of effect contour lines indicating the degree of the effect, and these contour lines can be superimposed upon an image of patient tissue. The displayed combination can be referred to as an effect distribution. Typically, the image is a cross section of the patient's tissue that is to receive the treatment or that is to be diagnosed, but it also can be a three dimensional image, with three dimensional effect contour lines.

The patient-specific and agent-specific information together with the administration information, which are combined for simulation or planning, can be a physical distribution of the agent or substance calculated from the administration information, e.g., from infusion sites and rates, and an agent or substance activity factor. The physical distribution can be a mathematical description of the patient's tissue that is to be subjected to therapy or diagnosis, and the distribution of the agent therein. This can be obtained typically through a computer calculation, for example. Once calculated, the physical distribution can be stored for retrieval when needed to calculate the effect distribution.

An agent activity factor can be the information concerning metabolization of the agent in the subject or interaction with another agent, which can be combined with the physical distribution to obtain the effect distribution. The agent activity factor itself can be a result that is derived from a combination of metabolization, loss, influx, efflux, dose or weighting factors as will be explained. Consequently, the effect distribution displayed as contour lines on a cross section of the patient's tissue is the predicted effect of the administered agent, e.g., the treatment based on the calculated physical distribution and the preselected agent activity factor(s). The method can be performed by a) calculating the physical distribution, b) determining the effect distribution by combining the physical distribution and the agent activity factor(s), and c) displaying the effect distribution as contour lines superimposed upon the patient's tissue.

The agent activity factor, or more accurately the factors which are used to derive the agent activity factor, can be obtained by in-vitro experiments and/or histological studies or imaging techniques. The method can adjust numerous agent activity factors that are combined together to reach a final agent activity factor.

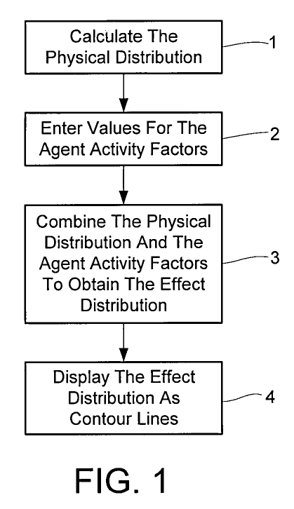

FIG. 1 is a flow chart illustrating an exemplary method for simulating the effect of an administered substance on a patient. Beginning at block 1, the physical distribution is obtained using conventional means. The physical distribution only needs to be calculated once and can be stored for retrieval in later calculations.

Next at block 2, values for the agent activity factors, such as, for example, the metabolization, loss, influx, efflux, dose or weighting factors, are entered. These agent activity factors can be adjusted using an automated or manual method. The automated method, for example, may be to automatically input or load the agent activity factors from a database. The manual method of entering agent activity factors may be via computer keyboard or the like.

The values can be modified by moving a cursor using any method known to those skilled in the art, such as with a mouse or moving between fields by tapping on a movement key (e.g., an arrow or tab key of a computer keyboard). The agent activity factors can be adjustable so as to enable entry of the metabolization parameters for respective different agents that are administered in combination, or to consider the interaction of different substances when administered.

At block 3, the agent activity factor(s) and the previously calculated physical distribution are used to generate the effect distribution. Then at block 4, the graphical representation of the effect distribution is displayed.

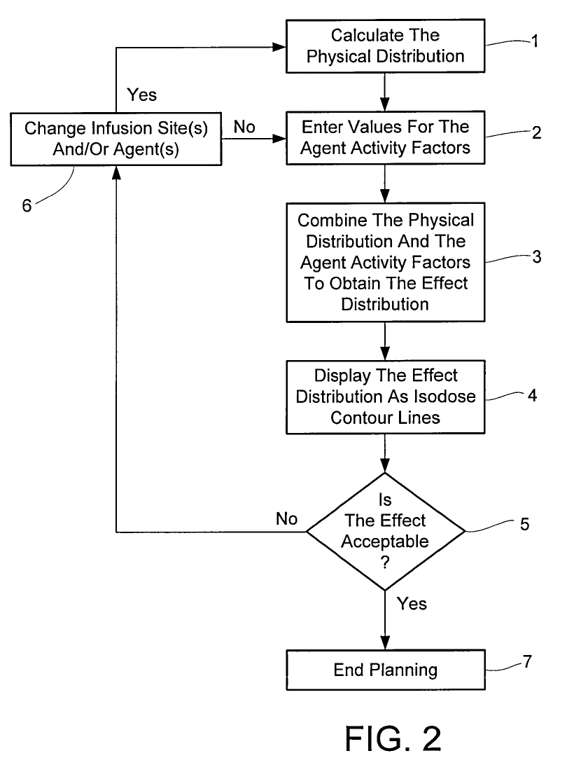

FIG. 2 shows a flow chart which adds additional steps to the method of FIG. 1. In this alternative embodiment, after generating the image at block 4, the planner may decide at block 5 whether or not the effect is acceptable (e.g., whether or not administration (e.g. infusion sites, delivery rates and/or the administered agent(s)) need to be modified to change the physical distribution of the agent in the subject as calculated at block 1 so as to obtain a more advantageous or acceptable effect distribution). If the effect is not acceptable, then at block 6 the administration is changed and the method moves back to block 1. If the effect is acceptable, then the method ends at block 7.

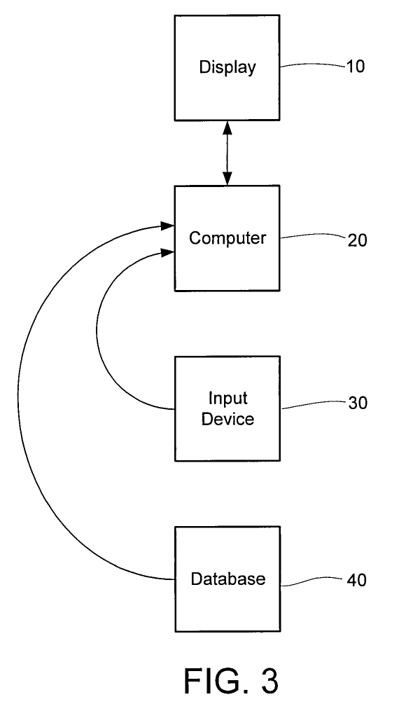

A system for executing the steps of the method described herein can include the components shown in block diagram form in FIG. 3:
(1) a graphical display 10 for displaying the effect distribution or “efficiency window”, preferably superimposed over an image of the patient's tissue;
(2) a means for carrying out the computations necessary for obtaining a physical distribution, the final agent activity factor(s) and the effect distribution. This means is typically a general purpose computer 20; and
(3) a means for entering the agent activity factors to be displayed and used in the effect distribution calculations, such as a computer keyboard 30 or a databank 40.

A person having ordinary skill in the art of computer programming and applications of programming for computer systems would be able in view of the description provided herein to program the computer 20 to operate and to carry out the functions described herein. Accordingly, details as to the specific programming code have been omitted for the sake of brevity. Also, while software in the memory or in some other memory of the computer and/or server may be used to allow the system to carry out the functions and features described herein in accordance with the preferred embodiment of the invention, such functions and features also could be carried out via dedicated hardware, firmware, software, or combinations thereof, without departing from the scope of the invention.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for simulating a distribution of at least one agent in a subject, comprising using the combination of subject-specific information, information concerning the administration of the at least one agent, and agent specific information to calculate an effect of the at least one agent in the subject, said effect including the alteration of the metabolism.

2. The method according to claim 1, wherein using subject-specific information includes using at least one of information concerning physiology, anatomy, vascular permeability, hydraulic conductivity and/or diffusivity as the subject-specific information.

3. The method according to claim 1, further comprising deriving the subject-specific information from at least one of MR scans, MRI diffusion scans, MRI dynamic contrast enhanced scans, MRI T1w scans, MRI T2w scans, MRI spectroscopy scans, CT perfusion scans, PET scans, SPECT scans, molecular imaging, CT, X-ray, ultrasound and/or electrography.

4. The method according to claim 1, wherein using agent-specific information includes using information concerning the metabolization or interaction of the at least one agent with the subject as the agent-specific information.

5. The method according to claim 4, wherein using information concerning metabolization or interaction of the at least one agent with the subject includes metabolization or interaction with a tissue and/or another agent.

6. The method according to claim 1, further comprising obtaining the agent-specific information by at least one of in-vitro experiments, histological studies and/or imaging techniques.

7. The method according to claim 1, wherein using information concerning the administration of the at least one agent includes using information concerning a mode of application of the at least one agent and parameters of the mode of application.

8. The method according to claim 7, wherein using information concerning the mode of application of the at least one agent includes using at least one of information concerning local, systematical or topical application of the at least one agent, and wherein parameters of the mode of application of the at least one agent include at least one of infusion or injection sites, delivery rate(s), distribution mechanism, loss, influx and/or efflux of the agent(s) in the subject.

9. The method according to claim 1, wherein calculating the effect of the at least one agent further includes calculating at least one of binding, necrosis, swelling, uptake, genetic alterations, physical alterations, chemical alterations, electrical alterations, morphologic alterations, mutations, or physiological alterations.

10. The method according to claim 1, further comprising assigning generalized data to portions of a volume of interest based on the subject-specific information and based on knowledge concerning anatomic or physiological segments occurring in the volume of interest.

11. The method according to claim 1, further comprising displaying a window of effectiveness that includes information concerning regions in which the information regarding effect of the at least one agent is pre-determined.

12. The method according to claim 1, further comprising using pressure-driven infusion delivery or diffusion mediated delivery to locally apply the at least one agent or portions thereof.

13. The method according to claim 12, wherein the at least one agent is a therapeutic agent and/or diagnostic substance.

14. The method according to claim 1, further comprising using a blood stream and/or other body fluids of a subject as the volume of interest or as a transport mechanism towards a volume of interest to systematically apply the at least one agent or portions thereof.

15. The method according to claim 1, further comprising using topical application to deliver the at least one agent as a volume of interest or as a transport mechanism towards the volume of interest.

16. The method according to claim 1, wherein the at least one agent is a plurality of agents, further comprising:
sequentially or simultaneously applying the plurality of agents; and
based on interactions of the plurality of agents with the subject, computing and displaying regions in which the plurality of agents have a pre-determined effect on a volume of interest within such subject.

17. The method according to claim 1, further comprising:
using energy to sequentially or simultaneously administer the at least one agent; and
based on interactions of the various substances and the energy with one another and with the subject, computing and displaying regions in which the at least one agent and the energy have a pre-determined effect on a volume of interest within such subject.

18. The method according to claim 1, further comprising displaying a property of an administered agent under consideration of the pre-determined effect or under consideration of one or more properties characterizing the pre-determined effect of the infused agent on a target volume.

19. A computer program embodied on a machine readable medium for simulating a distribution of at least one agent in a subject, comprising code that uses the combination of subject-specific information, information concerning the administration of the at least one agent, and agent specific information to calculate an effect of the at least one agent in the subject, said effect including the alteration of the metabolism.

20. A system for simulating the distribution of at least one agent in tissue of a subject, comprising:
a computer; and
logic stored in and executable by the computer, said logic including logic that uses the combination of subject-specific information, information concerning the administration of the at least one agent, and agent specific information to calculate an effect of the at least one agent in the subject, said effect including the alteration of the metabolism.

21. The system according to claim 20, further comprising an input device and/or database for inputting at least one agent activity factor and a physical distribution of the agent in the subject, wherein said logic uses the at least one agent activity factor and physical distribution of the agent in the subject to calculate the effect of the at least one agent in the subject.
